(19) United States
(12) Patent Application Publication
(10) Pub. No.: US 2011/0167006 A1
(43) Pub. Date: Jul. 7, 2011

(54) METHOD AND SYSTEM FOR A REAL-TIME CASE EXCHANGE IN A SERVICE MANAGEMENT ENVIRONMENT

(76) Inventors: HARISH KAMATH MANGALORE, Bangalore (IN); Balaji Chandrashekar, Bangalore (IN); Sachin M. Bisane, Bangalore (IN)

(21) Appl. No.: 12/651,460

(22) Filed: Jan. 2, 2010

(51) Int. Cl. G06Q 10/00; G06Q 50/00

(52) U.S. Cl. 705/301

(57) ABSTRACT

A method and system for real-time case exchange in a service management environment is disclosed. In one embodiment, a case is received by any one of customers, vendors, or managed service providers (MSP). Then, the case is forwarded by said any one of the customers, vendors, or MSPs to a real-time application for case exchange (RACE) in a customer/vendor/MSP specified data format. The forwarded case is transformed to a RACE specific data format by the RACE. Further, the transformed case is sent to customers, vendors, and/or MSPs substantially simultaneously in an associated customer/vendor/MSP specified data format by the RACE.

### FIELD OF TECHNOLOGY

Embodiments of the present invention relate to the field of service management. More particularly, embodiments of the present invention relate to real-time case exchange in a service management environment.

### BACKGROUND

Infrastructure management (IM) (also, referred to as service management) is a process of managing infrastructure assets of an enterprise. The IM may include monitoring, diagnosing, trouble shooting and managing the infrastructure assets of the enterprise. The infrastructure assets may include information technology (IT) assets, such as computers, servers, etc., telecom assets, such as voice over internet protocol (IP) phones, private branch exchange systems, etc., and non-IT assets, such as buildings, temperature controllers, etc. Basically, the IM ensures that the infrastructure is available in its fullest capacity for purposes of operating a business of the enterprise.

Typically, the IM for large enterprises is carried out by a managed service provider (MSP). A MSP is a vendor who provides IM as a service to the large enterprises. Further, the MSPs may in turn have multiple partners who are specialists in managing a particular infrastructure asset type and contribute to the IM process.

The MSPs may use a computerized case management system for managing a case assigned to them. A case is registered for every incident occurring at the infrastructure. The case may include details of the incident occurred along with the current status of resolution. The computerized case management systems can be either developed by a MSP or procured from various vendors. Currently, there is no universally standardized method to represent the case in the computerized case management system and each computerized case management system may follow its own standard.

Further, since multiple entities (e.g., enterprises, vendors, MSPs, etc.) are involved in the IM, the multiple entities may be required to communicate case information (e.g., health and status of rectification process) to other entities on a real-time basis. As the MSPs may use different computerized case management systems, the different computerized case management systems may not be capable of understanding the lifecycle of the case, validating the case and processing every transaction associated with the case due to the one or more problems explained below.

For example, every case has to go through a lifecycle from creation to closure. During the lifecycle, the case is transferred from one MSP to another several times. At times, it is possible that the case can get routed to an entity out of turn because of erroneous data, resulting in incomplete resolution of the case. Secondly, the validation mechanism present in any of the computerized case management systems may only validate the case received by it, accepting the case if correct and rejecting the case if failed. However, the validation mechanism may not be capable of routing the case to the associated entity in the event that the case is wrongly routed. Furthermore, in case of a multi vendor environment, since the computerized case management systems are based on multiple architectures, there may be no central monitoring system which can monitor the case throughout the lifecycle across the multiple vendors and across the architectures and provide validation mechanism appropriately.

The case information can also be manually exchanged between multiple entities through telephone or email. However, this approach may cause delay in the transactions. Also, central monitoring and reporting of the case is not possible with the manual exchange process.

### SUMMARY

A method and system for real-time case exchange in a service management environment is disclosed. According to one aspect of the invention, a computer implemented method for real-time case exchange in a service management environment includes receiving a case by any one of multiple customers, one of multiple vendors, or one of multiple managed service providers (MSPs). The method also includes forwarding the case by said any one of the multiple customers, one of the multiple vendors, or one of the multiple MSPs to a real-time application for case exchange (RACE) in a customer/vendor/MSP specified data format.

Further, the method includes transforming the forwarded case to a RACE specific data format by the RACE. In addition, the method includes sending the transformed case to one or more of the multiple customers, one or more of the multiple vendors, and/or one or more of the multiple MSPs substantially simultaneously in the associated customer/vendor/MSP specified data format by the RACE. The method may also include initiating a case by the service management application (SMA) associated with the RACE via the RACE to a SMA associated with the one or more of the multiple customers, the one or more of the multiple vendors, and/or the one or more of the multiple MSPs.

According to another aspect of the present invention, a non-transitory computer-readable storage medium having instructions that, when executed by a computing device, cause the computing device to perform the method for a real-time case exchange in a service management environment as described above.

According to yet another aspect of the present invention, a system for a real-time case exchange in a service management environment includes customers, vendors, and MSPs. The system also includes a remote management facility (RMF) connected to the customers, the vendors, and the MSPs via a network. The RMF includes a SMA and a RACE, where, any one of the customers, one of the vendors, or one of the MSPs receives a case and forwards the case in a customer/vendor/MSP specified data format to the RACE.

The RACE includes a data format transformation module for transforming the case from the customer/vendor/MSP specified data format to a RACE specific data format. The RACE also includes an integration module for sending the transformed case to the customers, the vendors, and/or the MSPs substantially simultaneously in the associated customer/vendor/MSP specified data format. Further, the RACE includes an authentication module for authenticating identified one of the customers, one of the vendors, or one of the MSPs and validating the customer/vendor/MSP specified data format associated with the forwarded case upon successful authentication of the identified one of the customers, one of the vendors, or one of the MSPs.

Moreover, the RACE includes an acknowledgement module for sending an unsuccessful acknowledgment to a SMA associated with the identified one of the customers, one of the vendors, or one of the MSPs upon unsuccessful authentication of the identified one of the customers, one of the vendors, or one of the MSPs prior to transforming the case into the RACE specific data format. The RACE also includes a life cycle validation module for validating the transformed case in the RACE specific data format for point-in-time life-cycle determination.

Further, the RACE includes a persistent module for storing the transformed case in memory of the RACE if the sent transformed case is not successfully delivered to at least one of the customers, the vendors, and/or the MSPs. The RACE also includes a scheduler module for scheduling resending of the transformed case stored by the persistent module at a predefined interval. In addition, the RACE includes a notification module for notifying the at least one of the customers, the vendors, and/or the MSPs that the case is unsuccessfully delivered.

The methods, and systems disclosed herein may be implemented in any means for achieving various aspects, and other features will be apparent from the accompanying drawings and from the detailed description that follow.

### BRIEF DESCRIPTION OF THE DRAWINGS

Various preferred embodiments are described herein with reference to the drawings, wherein:

FIG. 1 illustrates a service management environment implementing a real-time case exchange, according to one embodiment;

FIG. 2 is a block diagram showing various modules associated with a RACE of FIG. 1, according to one embodiment;

FIG. 3 illustrates a schematic representation of an exemplary transaction cycle associated with the RACE of FIG. 1, according to one embodiment;

FIG. 4 illustrates a process flow chart of an exemplary method for a real-time case exchange in a service management environment, according to one embodiment;

FIG. 5 illustrates an exemplary computing device operable for practicing various embodiments of the present invention; and

FIG. 6 illustrates an exemplary network environment or system operable for practicing various embodiments of the present invention.

The drawings described herein are for illustration purposes only and are not intended to limit the scope of the present disclosure in any way.

### DETAILED DESCRIPTION

A method and system for a real-time case exchange in a service management environment is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

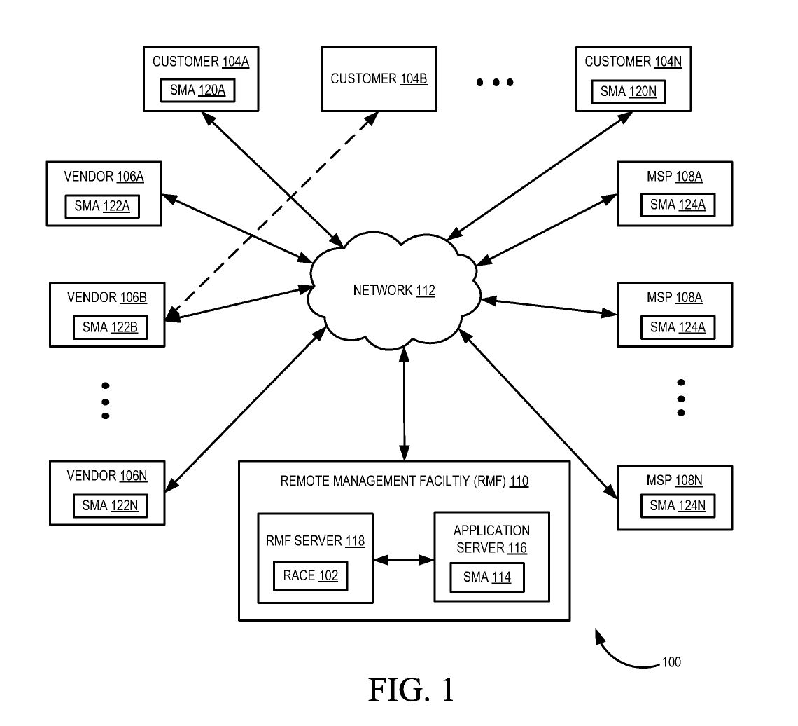

FIG. 1 illustrates a service management environment 100 implementing a real-time case exchange, according to one embodiment. As shown, the service management environment 100 includes customers 104A-N, vendors 106A-N, managed service providers (MSPs) 108A-N and a remote management facility (RMF) 110. The customers 104A-N, the vendors 106A-N, the MSPs 108A-N and the RMF 110 are connected to each other via a network 112.

Also, as illustrated, the RMF 110 includes a RMF server 118 having a RACE 102. The RMF 110 also includes a service management application (SMA) 114 residing in an application server 116. Further, as shown, the customers 104A-N, except the customer 104B, have SMAs 120A-N, the vendors 106A-N have SMAs 122A-N and the MSPs 108A-N have SMAs 124A-N.

The service management environment 100 may be associated with information technology (IT) service management environment, allied IT service management environment and non-IT service management environment. The RACE 102 is an application which provides seamless integration between different SMAs of the customers 104A-N, the vendors 106A-N and the MSPs 108A-N in the service management environment 100.

The customers 104A-N may be users of products (e.g., goods and/or services). The vendors 106A-N may be suppliers who provide the products to one or more of the customers 104A-N. The MSPs 108A-N may be vendors providing service management to organizations requiring service management. For example, the RMF 110 may be an MSP remotely providing monitoring and management services to the customers 104A-N, the vendors 106A-N or the MSPs 108A-N requiring service management.

Also, the RMF 110 may be partner to the MSPs 108A-N in providing service management as a service. The network 112 may be a Wide Area Network (WAN) or the Internet or a Local Area Network (LAN). The SMA 114 may be an application that manages and maintains list of cases to be serviced by the RMF 110. A case is a file including information associated with an event and support interventions made to resolve the event. The case may be a reactive case (e.g., a case raised by a user manually) or a proactive case (e.g., a case raised by a system upon automatic detection of a fault/event) and is registered for every event occurring in the service management environment 100. For example, in the IT service management environment, the case may be a failure of a computer or a server.

Consider a scenario where there occurs a failure in a computer system associated with the customer 104A. In such a case, the customer 104A registers a case (e.g., a ticket) using the SMA 120A in a customer specified data format (e.g., an extendable markup language (XML) format based on a Service Incident Specification (SIS) standard given by Consortium for Service Innovation (CSI), generally referred to as ‘CSI SIS’ standard. In one embodiment, the SMA 120A forwards the case in the customer specified data format to the RACE 102 via the network 112. The RACE 102 then transforms the case in the customer specified data format to a RACE specific data format.

Further, the RACE 102 validates the case in the RACE specific data format for point-in-time life cycle determination. For example, the point-in-life cycle determination may refer to a process of validating the case in the RACE specific data format at a given point of time based on the source or destination requirements. The source may be one of the customers 104A-N, one of the vendors 106A-N or one of the MSPs 108A-N and the destination may be the customers 104A-N, the vendors 106A-N and/or the MSPs 108A-N. Upon successful validation, the RACE 102 sends the transformed case to the SMA 114 associated with the RACE 102 for working on the transformed case. If the transformed case cannot be worked on by the SMA 114, then the SMA 114 initiates the transformed case via the RACE 102 to SMAs associated with the customers 104A-N, the vendors 106A-N and/or the MSPs 108A-N. In one exemplary implementation, the RACE 102 sends the transformed case to the customers 104A-N, the vendors 106A-N and/or the MSPs 108A-N, who can work on the transformed case or associated with the transformed case, via the network 112. In one example embodiment, the RACE 102 sends the transformed case in an associated customer/vendor/MSP specified data format via the network 112 for resolving the transformed case.

Consider another scenario where there occurs a failure in a computer system associated with customer 104B. The customer 104B is associated with the vendor 1068 and does not have an SMA. Hence, during requirements of service management, the customer 104B manually contacts the vendor 106B (e.g., via a telephone, mobile phone and the like) for registering a case. The vendor 106B, using the SMA 122B, registers the case and forwards the case in a vendor specified data format to the RACE 102 via the network 112. The RACE 102 transforms the forwarded case in the vendor specified data format to the RACE specific data format. Further, the transformed case is worked on by the SMA 114 or the RACE 102 sends the transformed case to associated customers 104A-N, vendors 106A-N and/or MSPs 108A-N for resolution. The vendor 102B communicates (e.g., via a telephone, mobile phone and the like) status of the forwarded case to the customer 1028 on a real-time basis.

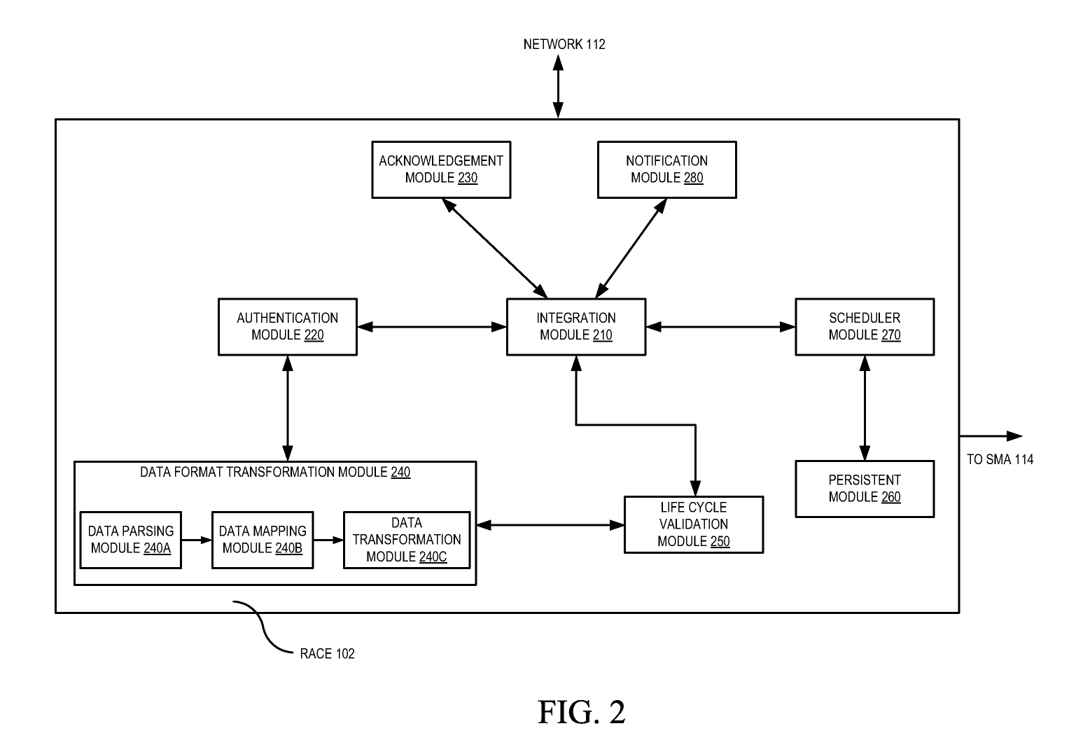

Thus, the RACE 102 can validate one or more cases received from the customers 104A-N, the vendors 106A-N and the MSPs 108A-N in the service management environment 100 and can understand the lifecycle of each of the one or more cases. Further, the RACE 102 centrally monitors each of the one or more cases throughout its lifecycle. The operation of the RACE 102 is described in greater detail in description of FIG. 2.

FIG. 2 is a block diagram showing various modules associated with the RACE 102 of FIG. 1, according to one embodiment. As shown, the RACE 102 includes an integration module 210, an authentication module 220, an acknowledgement module 230, a data format transformation module 240, a life cycle validation module 250, a persistent module 260, a scheduler module 270 and a notification module 280.

Consider that the SMA 120A associated with the customer 104A registers a case and forwards the case to the RACE 102 in a customer specified data format via the network 112. In one exemplary operation, the integration module 210 identifies the customer 104A associated with the forwarded case. Then, the authentication module 220 authenticates the identified customer 104A. Further, the authentication module 220 validates the customer specified data format associated with the forwarded case if the authentication is successful. Alternatively, if the authentication is unsuccessful, then the acknowledgement module 230 sends an unsuccessful acknowledgment to the SMA 120A associated with the identified customer 104A. In one exemplary implementation, the unsuccessful acknowledgment is sent prior to transforming the case into a RACE specific data format.

Once it is determined that the validation of the customer specified data format is successful, the data format transformation module 240 transforms the forwarded case from the customer specified data format to the RACE specific data format. In one embodiment, the data transformation module 210 includes a data parsing module 240A, a data mapping module 240B and a data transformation module 240C for transforming the forwarded case to the RACE specific data format. In one exemplary implementation, the data parsing module 240A parses the forwarded case in the customer specified data format. The data mapping module 240B maps data associated with one of the customers 104A-N, one of the vendors 106A-N, or one of the MSPs 108A-N in the parsed case to data associated with one or more of the customers 104A-N, the vendors 106A-N, and/or the MSPs 108A-N. Then, the data transformation module 240C transforms the forwarded case in the customer specified data format into the RACE specific data format based on the mapped data.

The life cycle validation module 250 validates the transformed case in the RACE specific data format for point-in-time life-cycle determination. The integration module 210 sends the transformed case to the SMA 114 associated with the RACE 102 for working on the transformed case if the validation is successful. If the validation is not successful, the acknowledgement module 230 sends an unsuccessful acknowledgment to the SMA 120A associated with the identified customer 104A via the network 112. The SMA 114 associated with the RACE 102 then determines whether the sent transformed case can be worked on by itself. If the sent transformed case can be worked on by the SMA 114, then the SMA 114 accepts the sent transformed case and works on the sent transformed case to resolve a transaction associated with the sent transformed case. If the SMA 114 determines that the sent transformed case cannot be worked on, then the integration module 210 determines, to which one or more of the customers 104A-N, the vendors 106A-N and/or the MSPs 108A-N, the transformed case has to be sent.

Further, the integration module 210 sends the transformed case to the determined customers, vendors and MSPs in an associated customer/vendor/MSP specified data format. In one embodiment, the integration module 210 sends the transformed case to the determined customers, vendors and MSPs substantially simultaneously in the associated customer/vendor/MSP specified data format. The customer/vendor/MSP specified data format may be an XML format based on the CSI SIS standard. Then, the integration module 210 determines whether the sent transformed case is successfully delivered to the determined customers, vendors and MSPs.

If it is determined that the sent transformed case is not successfully delivered to at least one of the determined customers, vendors and MSPs, the persistent module 260 stores the transformed case in memory of the RACE 102. Further, the scheduler module 270 schedules resending of the stored case at a predefined interval. In one embodiment, the integration module 210 resends the stored case at the predefined interval until the sent transformed case is successfully delivered to the at least one of the determined customers, vendors and MSPs. In case, the sent transformed case is not successfully delivered to the at least one of the determined customers, vendors and MSPs, the notification module 280 notifies the least one of the determined customers, vendors and MSP accordingly (e.g., via email, short messaging service, paging message and the like). Although, the above operation is made with respect to the customer 104A and its SMA 120A, one can envision that the various modules of the RACE 102 may perform similar operation when the RACE 102 receives a case from the customers 104B-N, the vendors 106A-N or the MSP 108A-N.

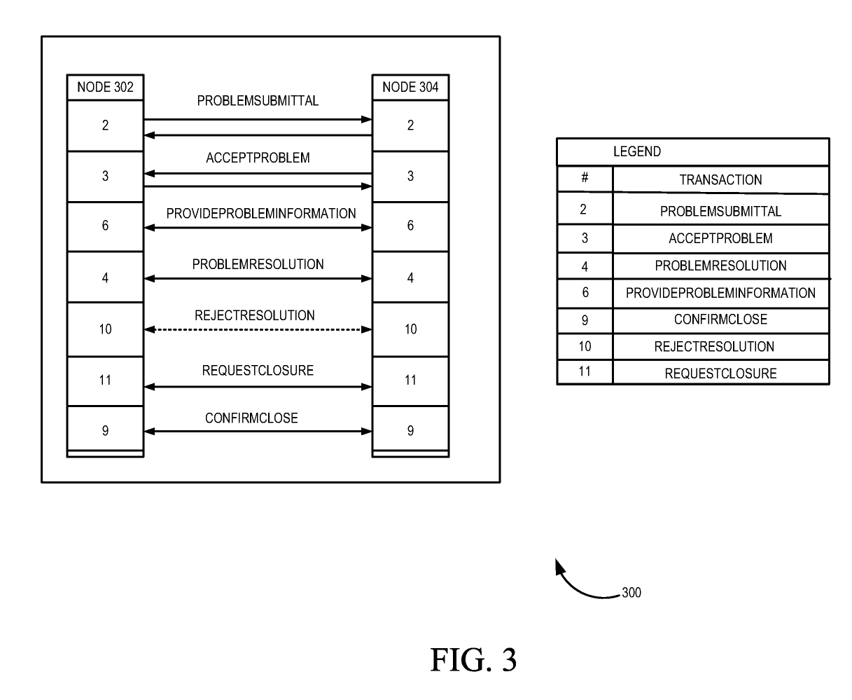

FIG. 3 illustrates a schematic representation 300 of an exemplary transaction cycle associated with the RACE 102, according to one embodiment. As shown in FIG. 3, a node 302 represents the RACE 102 and a node 304 represents an SMA associated with the customers 104A-N, the vendors 106A-N or the MSPs 108A-N. As illustrated, the node 302 validates a case received from the node 304 for point-in-time lifecycle determination. The case may be associated with a sequence of transactions including but not limited to problem submittal, accept problem, problem resolution, provide problem information, confirm close, reject resolution, request closure, and the like. Each of the above transactions can have a separate schema for each kind of interface. For example, for the problem submittal transaction, the customers 104A-N, the vendors 106A-N, and the MSPs 108A-N may follow a different XML schema. In such a case, the RACE enables normalizing of the problem submittal transaction received from the customers 104A-N, the vendors 106A-N, and the MSPs 108A-N.

The point-in-time lifecycle determination is performed based on the sequence of transactions associated with the case. For example, each time the node 302 receives the case, the case is validated for entire lifecycle of the case by examining sequence of the transactions. If a sequence of transaction is violated, then the transaction is not processed and an unsuccessful acknowledgement is sent to the node 304.

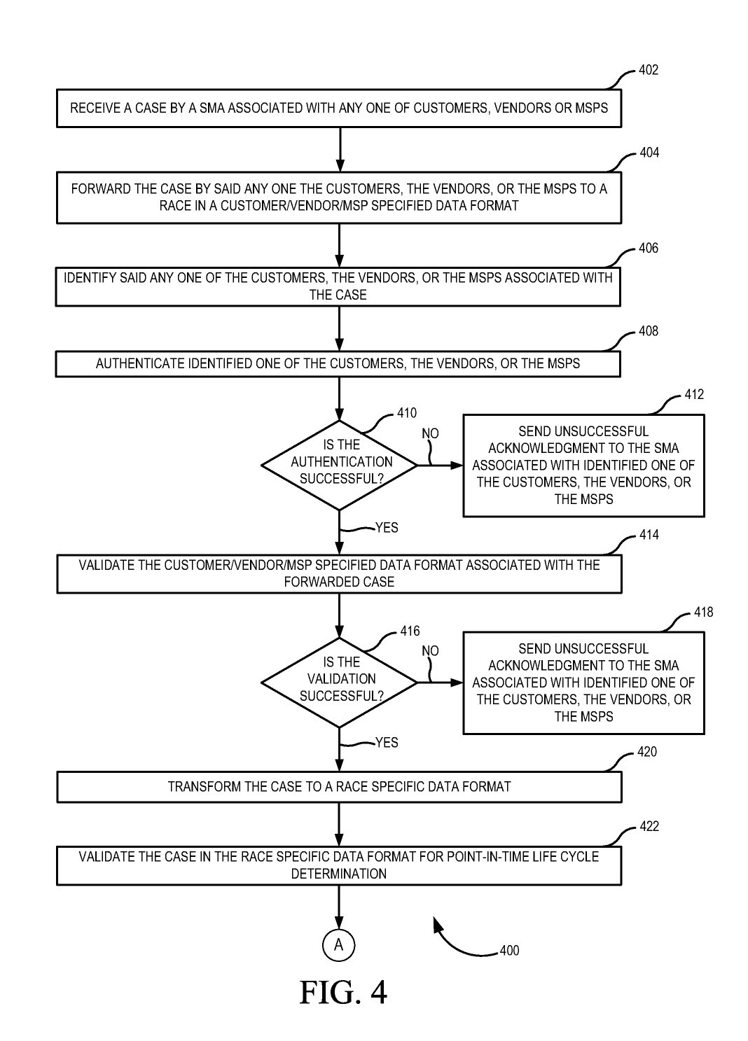

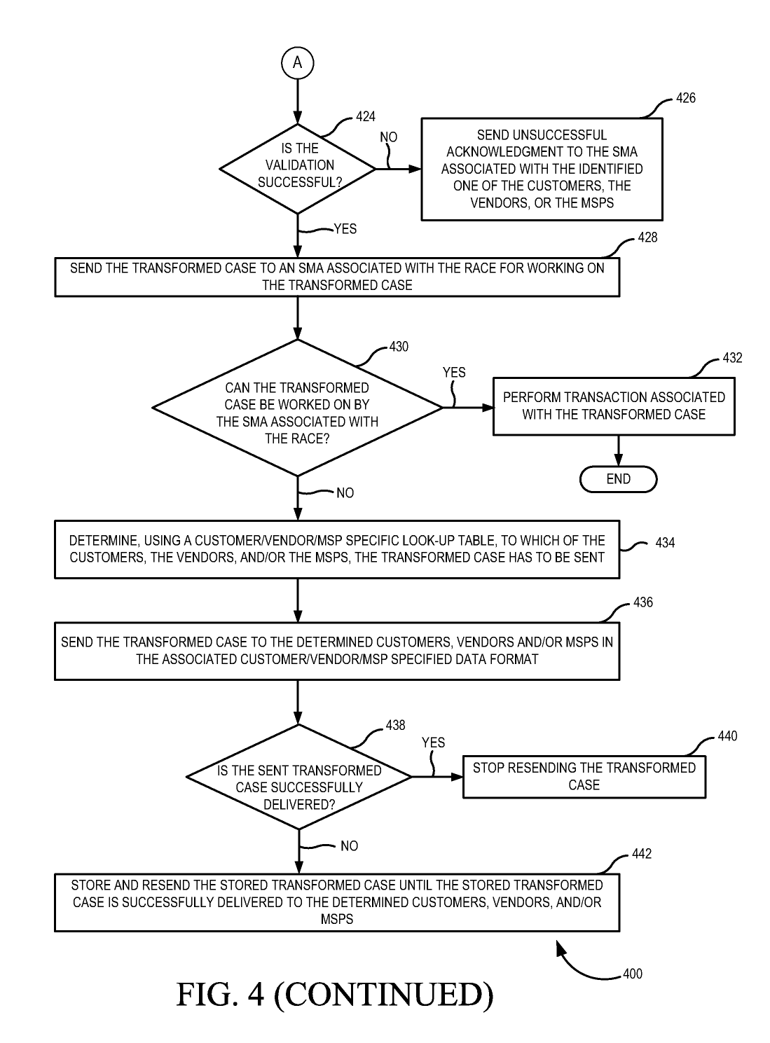

FIG. 4 illustrates a process flow chart of an exemplary method 400 for a real-time case exchange in a service management environment, according to one embodiment. In step 402, a case is received by a SMA associated with one of customers, vendors or MSPs. In step 404, the case is forwarded to a RACE by the one of the customers, the vendors, or the MSPs in a customer/vendor/MSP specified data format. In step 406, the one of the customers, the vendors, or the MSPs associated with the case is identified. In step 408, the identified one of the customers, the vendors, or the MSPs is authenticated.

In step 410, it is determined whether the authentication is successful. If the authentication is not successful, step 412 is performed in which unsuccessful acknowledgment is sent to the SMA associated with the identified one of the customers, the vendors, or the MSPs. If the authentication is successful, step 414 is performed in which the customer/vendor/MSP specified data format associated with the forwarded case is validated by the RACE. In step 416, it is determined whether the validation of the customer/vendor/MSP specified data format is successful. If it is determined that the validation is not successful, step 418 is performed in which unsuccessful acknowledgment is sent to the SMA associated with the one of the customers, the vendors, or the MSPs. If it is determined that the validation is successful, step 420 is performed in which the case is transformed from the customer/vendor/MSP specified data format to a RACE specific data format.

In step 422, the case in the RACE specific data format is validated for point-in-time life-cycle determination. In step 424, it is determined whether the validation of the case is successful. If it is determined that the validation is not successful, then step 426 is performed in which unsuccessful acknowledgment is sent to the SMA associated with the one of the customers, the vendors, or the MSPs. If it is determined that the validation of the case is successful, step 428 is performed in which the transformed case is sent to a SMA associated with the RACE for working on the transformed case.

In step 430, it is determined whether the sent transformed case can be worked on by the SMA associated with the RACE. If it is determined that the sent transformed case can be worked on by the SMA associated with the RACE, then step 432 is performed. In step 432, a transaction associated with the case is performed using the SMA associated with the RACE to resolve the transaction associated with the case.

If it is determined that the sent transformed case cannot be worked on by the SMA associated with the RACE, then step 434 is performed. In step 434, it is determined to which of the customers, the vendors, and/or the MSPs the transformed case has to be sent by the RACE using a customer/vendor/MSP specific look-up table. In step 436, the transformed case is sent to the determined one or more of the customers, the vendors and/or the MSPs in an associated customer/vendor/MSP specified data format by the RACE for resolution.

In step 438, it is determined whether the sent transformed case is successfully delivered to the determined one or more of the customers, the vendors and/or the MSPs. If it is determined that the sent transformed case is successfully delivered to at least one of the determined one or more of the customers, the vendors and/or the MSPs, then step 440 is performed. In step 440, resending the transformed case is stopped. If it is determined that the sent transformed case is not successfully delivered to at least one of the determined one or more of the customers, the vendors and/or the MSPs, then step 442 is performed.

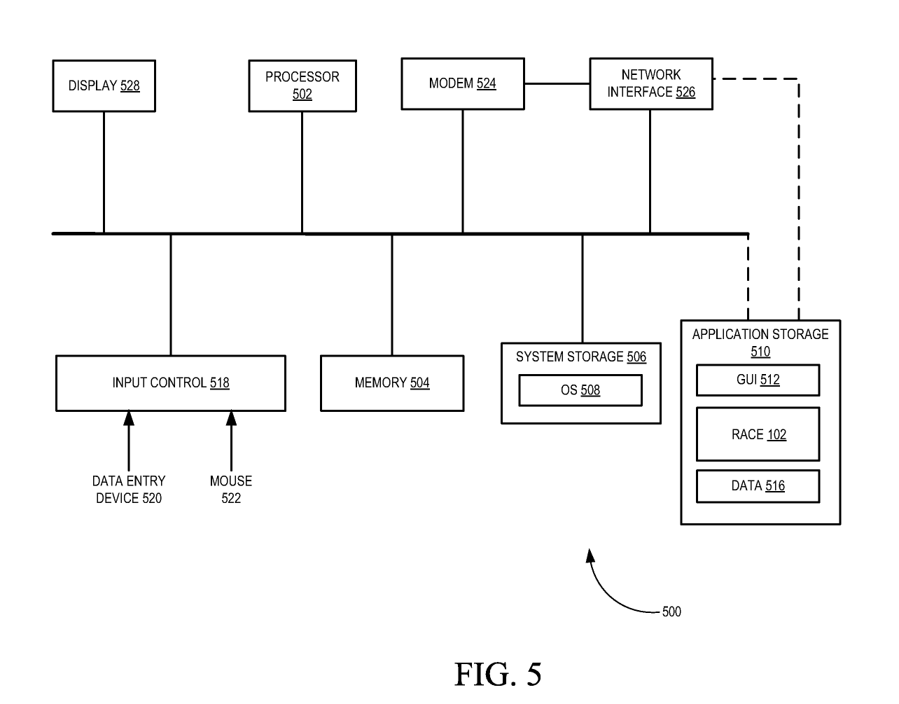

In step 442, the sent transformed case is stored and resent by the RACE until the stored transformed case is successfully delivered to the at least one of the determined one or more of the customers, the vendors, and/or the MSPs. Moreover, in one example embodiment, a non-transitory computer-readable storage medium having instructions for a real-time case exchange in a service management environment, that when executed by a computing device (e.g., a computing device 500 of FIG. 5), cause the computing device to perform the method illustrated in FIG. 4.

FIG. 5 illustrates an exemplary computing device 500 operable for practicing various embodiments of the present invention. One of ordinary skill in the art will appreciate that the computing device 500 is intended to be illustrative and not limiting of the present invention. The computing device 500 may take many forms, including but not limited to a workstation, server, network computer, quantum computer, optical computer, bio-computer, Internet appliance, mobile device, pager, tablet computer, and the like.

The computing device 500 may be an electronic device and includes a processor 502, a memory 504, a system storage 506 storing an operating system 508, an application storage 510 storing a graphical user interface (GUI) 512, the RACE 102, data 516, an input control 518 such as a data entry device 520 and a mouse 522, a modem 524, a network interface 526, a display 528, etc. The processor 502 controls each component of the computing device 500 for providing real-time case exchange in the service management environment 100.

The memory 504 temporarily stores instructions and data and provides the stored instructions and data to the processor 502 so that the processor 502 operates the computing device 500 for providing the real-time case exchange in the service environment 100 using the RACE 102. The system storage 506 includes code for the OS 508 of the computing device 500. The application storage 510 includes set of instructions for the RACE 102 running on the OS 508 which manages the real-time case exchange in the service environment 100 as well as the data 516 associated with the RACE 102. In one example implementation, the system storage 506 and the application storage 510 may be implemented using a single storage. In another example implementation, the GUI 512, the application 514, and the data 516 may be stored in different storage devices.

The input control 518 may interface with the data entry device 520, the mouse 522, and other input devices. The computing device 500 may receive, through the input control 518, input data necessary for the real-time case exchange. The computing device 500 may display user interfaces in the display 528 that help customers/vendors/MSPs to define user profiles and access controls in the service management environment 100. Moreover, the application storage 510 may interface with the computing device 500 directly with the bus of the computing device 500 or via the network interface 526.

In one embodiment, the computing device 500 or an apparatus for real-time case exchange in the service management environment 100 includes the processor 502 and the memory 504 coupled to the processor 502 for temporarily storing a set of instructions. The set of instructions, when executed by the processor 502, causes the processor 502 to perform a method including receiving a case by any one of multiple customers, one of multiple vendors, or one of multiple MSPs and forwarding the case by said any one of the multiple customers, the one of the multiple vendors, or the one of the multiple MSPs to the RACE 102 in a customer/vendor/MSP specified data format. The method also includes transforming the forwarded case to a RACE specific data format by the RACE 102. Further, the method includes sending the transformed case to one or more of the multiple customers, one or more of the multiple vendors and/or one or more of the multiple MSPs substantially simultaneously in an associated customer/vendor/MSP specified data format by the RACE 102.

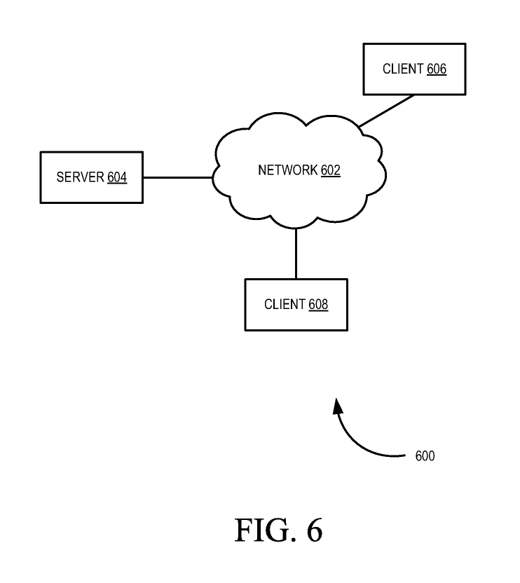

FIG. 6 illustrates an exemplary network environment 600 or system operable for practicing various embodiments of the present invention. The network environment 600 may include a server 604 coupled to clients 606 and 608 via a network 602 (e.g., a communication network). The server 604 and the clients 606 and 608 can be implemented using the computing device 500 depicted in FIG. 5.

The network interface 526 and the modem 524 of the computing device 500 enable the server 604 to communicate with the clients 606 and 608 through the network 602. The network 602 may include the Internet, intranet, LAN, WAN, etc. The communication facilities can support the distributed implementations of the present invention.

In the network environment 600, the server 604 may provide the clients 606 and 608 with software components or products under a particular condition, such as a license agreement. The software components or products may include those for the real-time case exchange in the service management environment 100 as illustrated in FIG. 1. The server 604 may send the clients 606 and 608 the software components or products under a specific license agreement.

In various embodiments, the systems and methods described in FIGS. 1 through 6 is capable of understanding lifecycle stages of every case independent of architecture used by a native SMA of any customers or vendors or MSPs. The RACE centrally monitors the case throughout its lifecycle across the customers or vendors or MSPs and validates and routes the case appropriately. Also, the RACE validates every transaction with the life-cycle of the case and maintains sequence of the transactions throughout the life-cycle. Thus, the RACE preserves integrity of sequence of incoming data.

Further, the RACE reduces the effort of rerouting the case assigned out of turn to another entity (e.g., customer, vendor, or MSP). Using the RACE, one can ensure correct flow of the case, thus ensuring compliance to service level agreements. Due to drastic reduction of manual intervention, significant human effort is reduced in the service management environment which generates thousands of transactions per day. Also, the above-described systems and methods do not depend on multiple frameworks/systems addressing the lifecycle of the case. The whole process is addressed by the RACE, thus saving on cost associated with hardware, software, maintenance, etc. The above-described system can be configured easily such that lower skilled resources can handle the framework rather than higher skilled resources.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present disclosure is not intended to be limited to the embodiments shown herein but is to be accorded the widest scope consistent with the principles and features disclosed herein.

What is claimed is:

1. A computer implemented method for real-time case exchange in a service management environment, comprising:
receiving a case by any one of multiple customers, one of multiple vendors, or one of multiple managed service providers;
forwarding the case by said any one of the multiple customers, one of the multiple vendors, or one of the multiple managed service providers to a RACE in a customer/vendor/managed service provider specified data format;
transforming the forwarded case to a RACE specific data format by the RACE; and
sending the transformed case to one or more of the multiple customers, one or more of the multiple vendors, and/or one or more of the multiple managed service providers substantially simultaneously in the associated customer/vendor/managed service provider specified data format by the RACE.

2. The method of claim 1, wherein the case comprises at least one of reactive case and proactive case.

3. The method of claim 1, wherein the service management environment is selected from the group consisting of information technology (IT) service management environment, allied IT service management environment, and non-IT service management environment.

4. The method of claim 1, wherein receiving the case by said any one of the multiple customers, one of the multiple vendors, or one of the multiple managed service providers, comprises:
receiving the case by a service management application associated with said any one of the multiple customers, one of the multiple vendors, or one of the multiple managed service providers.

5. The method of claim 4, wherein transforming the forwarded case to the RACE specific data format by the RACE comprises:
validating the customer/vendor/managed service provider specified data format associated with the forwarded case from said any one of the multiple customers, one of the multiple vendors, or one of the multiple managed service providers by the RACE;
upon successful validation of the customer/vendor/managed service provider specified data format, transforming the forwarded case to the RACE specific data format; and
upon unsuccessful validation of the customer/vendor/managed service provider specified data format, sending an unsuccessful acknowledgment to the service management application associated with said any one of the multiple customers, one of the multiple vendors, or one of the multiple managed service providers.

6. The method of claim 5, wherein validating the customer/vendor/managed service provider specified data format associated with the forwarded case from said any one of the multiple customers, one of the multiple vendors, or one of the multiple managed service providers by the RACE, comprises:
identifying said any one of the multiple customers, one of the multiple vendors, or one of the multiple managed service providers associated with the forwarded case;
authenticating the identified one of the multiple customers, one of the multiple vendors, or one of the multiple managed service providers;
upon successful authentication of the identified one of the multiple customers, one of the multiple vendors, or one of the multiple managed service providers, validating the customer/vendor/managed service provider specified data format associated with the forwarded case by the RACE; and
upon unsuccessful authentication of the identified one of the multiple customers, one of the multiple vendors, or one of the multiple managed service providers, sending an unsuccessful acknowledgment to the service management application associated with the identified one of the multiple customers, one of the multiple vendors, or one of the multiple managed service providers.

7. The method claim 5, wherein sending the transformed case to one or more of the multiple customers, one or more of the multiple vendors, and/or one or more of the multiple managed service providers, comprises:
validating the case that is in RACE specific data format for point-in-time life-cycle determination;
upon successful validation, sending the transformed case to a service management application associated with the RACE for working on the transformed case;
determining by the service management application associated with the RACE whether the sent transformed case can be worked on by the service management application associated with the RACE;
if not, determining to which of the one or more of the multiple customers, one or more of the multiple vendors, and/or one or more of the multiple managed service providers, the transformed case has to be sent by the RACE; and
sending the transformed case to one or more of the multiple customers, one or more of the multiple vendors, and/or one or more of the multiple managed service providers in the associated customer/vendor/managed service provider specified data format by the RACE based on the determination.

8. The method of claim 7, wherein determining to which of the one or more of the multiple customers, one or more of the multiple vendors, and/or one or more of the multiple managed service providers, the transformed case has to be sent by the RACE, comprises:
determining, using a customer/vendor/managed service provider specific look-up table, to which of the one or more of the multiple customers, one or more of the multiple vendors, and/or one or more of the multiple managed service providers, the transformed case has to be sent by the RACE.

9. The method of claim 6, wherein the customer/vendor/managed service provider specified data format is an extended markup language format based on Service Incident Specification (SIS) standard given by Consortium for Service Innovation (CSI).

10. The method of claim 6, wherein sending the transformed case to the one or more of the multiple customers, one or more of the multiple vendors, and/or one or more of the multiple managed service providers, further comprises:
determining whether the sent transformed case was successfully delivered to the one or more of the multiple customers, one or more of the multiple vendors, and/or one or more of the multiple managed service providers;
if so, stop resending the transformed case; and
if not, storing and resending the stored transformed case by the RACE until the stored transformed case is successfully delivered to the one or more of the multiple customers, one or more of the multiple vendors, and/or one or more of the multiple managed service providers.

11. The method of claim 1, further comprising:
initiating a case by the service management application associated with the RACE via the RACE to a service management application associated with the one or more of the multiple customers, one or more of the multiple vendors, and/or one or more of the multiple managed service providers.

12. A non-transitory computer-readable storage medium for a real-time case exchange in a service management environment having instructions that, when executed by the computer, cause the computer to perform a method comprising:
receiving a case by any one of multiple customers, one of multiple vendors, or one of multiple managed service providers;
forwarding the case by said any one of the multiple customers, one of the multiple vendors, or one of the multiple managed service providers to a RACE in a customer/vendor/managed service provider specified data format;
transforming the forwarded case to a RACE specific data format by the RACE; and
sending the transformed case to one or more of the multiple customers, one or more of the multiple vendors, and/or one or more of the multiple managed service providers substantially simultaneously in the associated customer/vendor/managed service provider specified data format by the RACE.

13. The non-transitory computer-readable storage medium of claim 12, wherein the case comprises at least one of a reactive case and a proactive case.

14. The non-transitory computer-readable storage medium of claim 12, wherein the service management environment is selected from the group consisting of information technology (IT) service management environment, allied IT service management environment, and non-IT service management environment.

15. The non-transitory computer-readable storage medium of claim 12, wherein receiving the case by said any one of the multiple customers, one of the multiple vendors, or one of the multiple managed service providers, comprises:
receiving the case by a service management application associated with said any one of the multiple customers, one of the multiple vendors, or one of the multiple managed service providers.

16. The non-transitory computer-readable storage medium of claim 15, wherein transforming the case to the RACE specific data format by the RACE comprises:
validating the customer/vendor/managed service provider specified data format associated with the forwarded case from said any one of the multiple customers, one of the multiple vendors, or one of the multiple managed service providers by the RACE;
upon successful validation of the customer/vendor/managed service provider specified data format, transforming the case to the RACE specific data format; and
upon unsuccessful validation of the customer/vendor/managed service provider specified data format, sending an unsuccessful acknowledgment to the service management application associated with said any one of the multiple customers, one of the multiple vendors, or one of the multiple managed service providers.

17. The non-transitory computer-readable storage medium of claim 16, wherein validating the customer/vendor/managed service provider specified data format associated with the forwarded case from said any one of the multiple customers, one of the multiple vendors, or one of the multiple managed service providers by the RACE, comprises:
identifying said one of the multiple customers, one of the multiple vendors, or one of the multiple managed service providers associated with the forwarded case;
authenticating the identified one of the multiple customers, one of the multiple vendors, or one of the multiple managed service providers;
upon successful authentication of the identified one of the multiple customers, one of the multiple vendors, or one of the multiple managed service providers, validating the customer/vendor/managed service provider specified data format associated with the forwarded case by the RACE; and
upon unsuccessful authentication of the identified one of the multiple customers, one of the multiple vendors, or one of the multiple managed service providers, sending an unsuccessful acknowledgment to the service management application associated with the identified one of the multiple customers, one of the multiple vendors, or one of the multiple managed service providers.

18. The non-transitory computer-readable storage medium of claim 16, wherein sending the transformed case to the one or more of the multiple customers, one or more of the multiple vendors, and/or one or more of the multiple managed service providers, comprises:
validating the case that is in RACE specific data format for point-in-time life-cycle determination;
upon successful validation, sending the transformed case to a service management application associated with the RACE for working on the transformed case;
determining by the service management application associated with the RACE whether the sent transformed case can be worked on by the service management application associated with the RACE;
if not, determining to which of the one or more of the multiple customers, one or more of the multiple vendors, and/or one or more of the multiple managed service providers, the transformed case has to be sent by the RACE; and
sending the transformed case to the one or more of the multiple customers, one or more of the multiple vendors, and/or one or more of the multiple managed service providers in the associated customer/vendor/managed service provider specified data format by the RACE based on the determination.

19. The non-transitory computer-readable storage medium of claim 17, wherein determining to which of the one or more of the multiple customers, one or more of the multiple vendors, and/or one or more of the multiple managed service providers, the transformed case has to be sent by the RACE, comprises:
determining, using a customer/vendor/managed service provider specific look-up table, to which of the one or more of the multiple customers, one or more of the multiple vendors, and/or one or more of the multiple managed service providers, the transformed case has to be sent by the RACE.

20. The non-transitory computer-readable storage medium of claim 17, wherein the customer/vendor/managed service provider specified data format is in extended markup language (XML) format based on a Service Incident Specification (SIS) standard given by Consortium for Service Innovation (CSI).

21. The non-transitory computer-readable storage medium of claim 17, wherein sending the transformed case to the one or more of the multiple customers, one or more of the multiple vendors, and/or one or more of the multiple managed service providers, further comprises:
determining whether the sent transformed case was successfully delivered to the one or more of the multiple customers, one or more of the multiple vendors, and/or one or more of the multiple managed service providers;
if so, stop resending the transformed case; and
if not, storing and resending the stored transformed case by the RACE until the stored transformed case is successfully delivered to the one or more of the multiple customers, one or more of the multiple vendors, and/or one or more of the multiple managed service providers.

22. A system for real-time case exchange, comprising
one or more customers;
one or more vendors;
one or more managed service providers, wherein any one of the one or more customers, one of the one or more vendors, or one of the one or more managed service providers receives a case;
a remote management facility (RMF) connected to the one or more customers, the one or more vendors, and the one or more managed service providers via a network, wherein the RMF comprises:
a service management application; and
a RACE, wherein the any one of the one or more customers, the one of the one or more vendors, or the one of one or more managed service providers forwards the case in a customer/vendor/managed service provider specified data format to the RACE, wherein the RACE comprises:
a data format transformation module for transforming the case from the customer/vendor/managed service provider specified data format to a RACE specific data format;
an integration module for sending the transformed case to the one or more customers, the one or more vendors, and/or the one or more managed service providers substantially simultaneously in an associated customer/vendor/managed service provider specified data format.

23. The system of claim 22, wherein the integration module identifies the one of the one or more customers, the one of one or more vendors, or the one of the one or more managed service providers associated with the forwarded case.

24. The system of claim 23, further comprising an authentication module for authenticating the identified one of the one or more customers, the one or more vendors, or the one or more managed service providers and validating the customer/vendor/managed service provider specified data format associated with the forwarded case upon successful authentication of the identified one of the one or more customers, the one or more vendors, or the one or more managed service providers.

25. The system of claim 24, further comprising an acknowledgement module for sending an unsuccessful acknowledgment to a service management application associated with the identified one of the one or more customers, the one or more vendors, or the one or more managed service providers upon unsuccessful authentication of the identified one of the one or more customers, one of the one or more vendors, or one of the one or more managed service providers prior to transforming the case into the RACE specific data format.

26. The system of claim 25, further comprising a life cycle validation module for validating the transformed case in the RACE specific data format for point-in-time life-cycle determination.

27. The system of claim 26, wherein the integration module sends the transformed case to a service management application associated with the RACE for working on the transformed case upon successful validation of the transformed case.

28. The system of claim 27, wherein the integration module determines, to which of the one or more customers, the one or more vendors, and/or the one or more managed service providers, the transformed case has to be sent if the service management application associated with the RACE determines that the sent transformed case cannot be worked on by the service management application associated with the RACE.

29. The system of claim 28, wherein the integration module sends the transformed case to the determined one or more customers, one or more vendors, and/or one or more managed service providers in the associated customer/vendor/managed service provider specified data format.

30. The system of claim 29, further comprising a persistent module for storing the transformed case in memory of the RACE if the sent transformed case is not successfully delivered to at least one of the determined one or more customers, one or more vendors, and/or one or more managed service providers.

31. The system of claim 30, further comprising a scheduler module for scheduling resending of the transformed case stored by the persistent module at a predefined interval.

32. The system of claim 31, wherein the integration module resends the stored transformed case until the stored transformed case is successfully delivered to the at least one of the one or more customers, one or more vendors, and/or one or more managed service providers.

33. The system of claim 32, further comprising a notification module for notifying the at least one of the one or more customers, the one or more vendors, and/or the one or more managed service providers that the stored transformed case is unsuccessfully delivered.

34. The system of claim 22, wherein the data format transformation module comprises:
a data parsing module for parsing the forwarded case in the customer/vendor/managed service provider specified data format;
a data mapping module for mapping data in the parsed case; and
a data transformation module for transforming the case in the customer/vendor/managed service provider specified data format to the RACE specific data format based on the mapped data.

35. The system of claim 34, wherein the customer/vendor/managed service provider specified data format is in an extendable markup language (XML) format based on Service Incident Specification (SIS) standard given by Consortium for Service Innovation (CSI).
